(19) United States
(12) Patent Application Publication
(10) Pub. No.: US 2006/0255298 A1
(43) Pub. Date: Nov. 16, 2006

(54) Laser produced plasma EUV light source with pre-pulse

(75) Inventors: Alexander N. Bykanov, San Diego, CA (US); Oleh Khodykin, San Diego, CA (US)

Correspondence Address: Matthew K. Hillman;Cymer, Inc., Legal Dept., MS/4-2C, 17075 Thornmint Court, San Diego, CA, 92127-2413, US

(73) Assignee: Cymer, Inc., San Diego, CA (US)

(21) Appl. No.: 11/358,988

(22) Filed: Feb. 21, 2006

Related U.S. Application Data
(63) Continuation-in-part of application No. 11/067,124, filed on Feb. 25, 2005.
(63) Continuation-in-part of application No. 11/174,443, filed on Jun. 29, 2005.

(51) Int. Cl. G01J 3/10

(52) U.S. Cl. 250/504 R

(57) ABSTRACT

A method for generating EUV light is disclosed which may include the acts/steps of providing a source material; generating a plurality of source material droplets; simultaneously irradiating a plurality of source material droplets with a first light pulse to create irradiated source material; and thereafter exposing the irradiated source material to a second light pulse to generate EUV light, e.g. by generating a plasma of the source material. In another aspect, an EUV light source may include a droplet generator delivering a plurality of source material droplets to a target volume; a source of a first light pulse for simultaneously irradiating a plurality of droplets in the target volume to produce an irradiated source material; and a source of a second light pulse for exposing the irradiated source material to generate EUV light. The droplet generator may comprise a non-modulating droplet generator and may comprise a multi-orifice nozzle.

The present application is a continuation-in-part application of co-pending U.S. patent application Ser. No. 11/067,124 filed on Feb. 25, 2005, entitled METHOD AND APPARATUS FOR EUV PLASMA SOURCE TARGET DELIVERY, attorney docket number 2004-0008-01, the entire contents of which are hereby incorporated by reference herein.

The present application is also a continuation-in-part application of co-pending U.S. patent application Ser. No. 11/174,443 filed on Jun. 29, 2005, entitled LPP EUV PLASMA SOURCE MATERIAL TARGET DELIVERY SYSTEM, attorney docket number 2005-0003-01, the entire contents of which are hereby incorporated by reference herein.

The present application is also related to co-pending U.S. nonprovisional patent application entitled SOURCE MATERIAL DISPENSER FOR EUV LIGHT SOURCE filed concurrently herewith, attorney docket number 2005-0102-01, the entire contents of which are hereby incorporated by reference herein.

The present application is also related to co-pending U.S. nonprovisional patent application entitled LASER PRODUCED PLASMA EUV LIGHT SOURCE filed concurrently herewith, attorney docket number 2005-0081-01, the entire contents of which are hereby incorporated by reference herein.

The present application is also related to co-pending U.S. provisional patent application entitled EXTREME ULTRAVIOLET LIGHT SOURCE filed concurrently herewith, attorney docket number 2006-0010-01, the entire contents of which are hereby incorporated by reference herein.

### FIELD OF THE INVENTION

The present invention relates to extreme ultraviolet (“EUV”) light sources which provide EUV light from a plasma that is created from a source material and collected and directed to a focus for utilization outside of the EUV light source chamber, e.g., for semiconductor integrated circuit manufacturing photolithography e.g., at wavelengths of around 50 nm and below.

### BACKGROUND OF THE INVENTION

Extreme ultraviolet (“EUV”) light, e.g., electromagnetic radiation having wavelengths of around 50 nm or less (also sometimes referred to as soft x-rays), and including light at a wavelength of about 13.5 nm, can be used in photolithography processes to produce extremely small features in substrates, e.g., silicon wafers.

Methods to produce EUV light include, but are not necessarily limited to, converting a material into a plasma state that has an element, e.g., xenon, lithium or tin, with an emission line in the EUV range. In one such method, often termed laser produced plasma (“LPP”) the required plasma can be produced by irradiating a target material, such as a droplet, stream or cluster of material having the required line-emitting element, with a laser beam. Heretofore, systems have been disclosed in which each droplet is sequentially irradiated by a separate laser pulse to form a plasma from each droplet. Also, systems have been disclosed in which each droplet is sequentially illuminated by a separate pre-pulse, e.g. light pulse, (one pre-pulse per droplet) prior to irradiation by a plasma-producing pulse (e.g. main laser pulse) sufficient to generate EUV from the pre-pulsed source material.

By way of example, for Sn and Li source materials, the source material may be heating above its respective melting point and forced through an orifice to produce a droplet. However, this type of non-modulated jet, typically generates a stream which subsequently breaks into droplets rather chaotically. The result is generally a large variation in droplet size and poor control over the positional stability of droplets both along the droplet path and in a plane normal to the path of the droplets.

Thus, for the single light pulse (not including pre-pulse(s)) per droplet scheme described above, it may be necessity to deliver the droplets precisely into a relatively small laser—droplet interaction region. Moreover, for this type of laser-droplet interaction, it is typically necessary for the beam spot to be smaller in the interaction area than the droplet diameter to approach 100% coupling. For this scheme, even small misalignments may lead to non-effective coupling between the droplet and laser pulse resulting in reduced EUV output and a relatively low conversion efficiency between the input power and the output EUV power. To increase the coupling between droplet and laser, some implementations have been developed to establish a modulated stream of droplets in which the source material may be passed through a capillary tube and an electro-actuatable element, e.g. piezoelectric (PZT) material, may be used to squeeze the capillary tube and modulate a release of source material from the tube into a relatively uniform stream of droplets.

As used herein, the term “electro-actuatable element” and its derivatives, means a material or structure which undergoes a dimensional change when subjected to a voltage, electric field, magnetic field, or combinations thereof and includes but is not limited to piezoelectric materials, electrostrictive materials and magnetostrictive materials. Typically, electro-actuatable elements operate efficiently and dependably within a somewhat narrow range of temperatures, with some PZT materials having a maximum operational temperature of about 250 degrees Celsius. For some target materials, this temperature is close to the melting point of target material. For example, the melting point of Sn is 231 degrees Celsius, which leaves very narrow margin for operation range of the PZT. Moreover, with only a small difference between the melting point of the target material and the maximum operating temperature of the PZT, clogging or partial clogging of the nozzle may occur due to source material freezing on the surface of the capillary tube.

For non-modulated droplet nozzles, the source material, e.g. Sn, Li, etc. may be heated well above its melting point. Since there is no PZT, and this additional heating tends to minimize nozzle clogging. On the other hand, use of a PZT may also contribute to nozzle clogging due to the ultrasonic waves that are created when the PZT operates. These ultrasonic waves are efficiently transferred through the molten target material and may result in ultrasonic cleaning of the inner surfaces of the source material reservoir. This cleaning, in turn, may wash out residual chunks that can clog the small nozzle orifice. Thus, the use of electro-actuatable elements to modulate droplet formation tend to increase system complexity, may cause nozzle clogging and/or the use of electro-actuatable elements may be limited to certain source materials.

Once generated, the droplet may travel within a vacuum chamber, e.g. due to it's momentum and/or under the influence of gravity or some other force, to an irradiation site where the droplet is irradiated, e.g. by a laser beam, and generate a plasma. For this process, the plasma is typically produced in a sealed vessel, e.g., vacuum chamber, and monitored using various types of metrology equipment. In addition to generating EUV radiation, these plasma processes also typically generate undesirable by-products in the plasma chamber (e.g. debris) which can potentially damage or reduce the operational efficiency of the various plasma chamber optical elements. This debris can include heat, high energy ions and scattered debris from the plasma formation, e.g., atoms and/or clumps/microdroplets of source material. For this reason, it is often desirable to employ one or more techniques to minimize the types, relative amounts and total amount of debris formed for a given EUV output power. When the target size, e.g. droplet diameter, and/or target makeup, e.g. chemistry, are chosen to minimize debris, the targets are sometimes referred to as so-called “mass limited” targets.

CO₂ lasers present certain advantages in LPP process, especially for certain targets, and these advantages may include the ability to produce a relatively high conversion efficiency between the input power and the output EUV power. However, one disadvantage of using a CO₂ laser in certain applications is the inability to focus 10.6 μm radiation tightly. For example, consider a typical “mass limited” Sn droplet having a diameter of less than 100 microns and a CO₂ laser focusing scheme which utilizes a lens with focal distance of about 50 cm to focus the laser radiation onto the 100 micron droplet. To focus a beam, e.g. CO₂ laser beam, in such a scheme, the divergence of the beam would typically need to be less than about 0.01/50=0.2 mrad. However, this value is less than the diffraction limit for the 10.6 um radiation with 50 mm aperture at the lens position: D_{difr}=1.22*10.6*10ˆ(−6)/50*10ˆ(−3)=2.6 mrad and, thus, cannot be reached. To overcome this limitation either the focal distance has to be decreased or the lens (laser beam) diameter has to be increased. Unfortunately, both of these improvements have disadvantages. For example, the LPP plasma may be formed inside an elliptical collector with the laser passing through an opening in the collector to reach the irradiation site. With this setup, decreasing the focal distance or increasing the lens (laser beam) diameter generally requires that the size of the collector opening be increased. This, in turn, may reduce EUV collection angle and necessitate complex schemes for protecting the laser input window from debris.

LPP EUV light sources are typically designed to produce light for use by an optical apparatus such as a lithography scanner. In some cases, these optical apparatus, due to their construction, may place a limit on the volume in which light generated by the EUV light source is usable by the apparatus. In addition, some light using optical apparatuses, e.g. scanners, are designed to operate more efficiently with a smaller light source volume (i.e. for the scanner designer, a smaller light source volume is better). This optical characteristic of a light source is commonly known as Etendue number. To summarize, the ability to focus a plasma initiating laser may establish the minimum size for an irradiation volume while the Etendue number may limit the maximum volume.

With the above in mind, Applicants disclose a laser produced plasma EUV light source with pre-pulse, and corresponding methods of use.

### SUMMARY OF THE INVENTION

In a first aspect, a method for generating EUV light may include the acts/steps of providing a source material; generating a plurality of source material droplets; simultaneously irradiating a plurality of source material droplets with a first light pulse to create irradiated source material; and thereafter exposing the irradiated source material to a second light pulse to generate EUV light, e.g. by generating a plasma of the source material. In a particular implementation, the irradiated source material may comprise vaporized source material. In one implementation, the irradiated source material may comprise a weak plasma. Depending on the application, one or both of the light pulses may be generated by a CO₂ laser, the source material may comprises Sn and the source material droplets may have a diameter in the range of 5 μm to 100 μm, and in some cases a diameter in the range of 5 μm to 15 μm.

In another implementation, a method for generating EUV light may include the acts/steps of providing a source material; generating at least one source material droplet; irradiating the at least one source material droplet with a first light pulse to create irradiated source material; and exposing the irradiated source material to a second light pulse to generate EUV light. For this implementation, the second light pulse may be focused to a focal spot having a focal spot size, and a predetermined period of time may be allowed to pass between the irradiating act and the exposing act to allow the irradiated source material to expand to at least the focal spot size before initiating the exposing act. For example, the predetermined time may be several microseconds.

In another aspect, an EUV light source may include a droplet generator delivering a plurality of source material droplets to a target volume; a source of a first light pulse for simultaneously irradiating a plurality of source material droplets in the target volume with the first pulse to produce an irradiated source material; and a source of a second light pulse for exposing the irradiated source material to the second light pulse to generate EUV light. In one embodiment, the droplet generator may comprise a non-modulating droplet generator. In a particular embodiment, the droplet generator may comprise a multi-orifice nozzle. In one particular embodiment, the droplet generator may comprise a source material reservoir having a wall and formed with an orifice and an electro-actuatable element spaced from the wall and operable to deform the wall and modulate a release of source material from the droplet generator.

### BRIEF DESCRIPTION OF THE DRAWINGS

FIG. 1 shows a schematic view of an overall broad conception for a laser-produced plasma EUV light source according to an aspect of the present invention;

FIG. 2 shows a schematic view of a source material filter/dispenser assembly;

FIG. 3 shows a schematic view of a non-modulating, single orifice, source material dispenser which generates a plurality of droplets for simultaneous irradiation at a target volume by a light pulse to vaporize and expand the source material for subsequent exposure to a laser pulse to generate an EUV emission;

FIG. 4 shows a schematic view of a non-modulating, multiple orifice, source material dispenser which generates a plurality of droplets for simultaneous irradiation at a target volume by a light pulse to vaporize and expand the source material for subsequent exposure to a laser pulse to generate an EUV emission;

FIG. 5 shows a sectional view as seen along line 5-5 in FIG. 4 showing the multiple orifice dispenser;

FIG. 6A-C illustrate the expansion of source material after three droplets are simultaneously irradiated by a light pulse;

FIG. 7A-C illustrate three different embodiment of a light pulse source for generating a pre-pulse and main-pulse and delivering the pulses to target location(s).

### DETAILED DESCRIPTION OF PREFERRED EMBODIMENTS

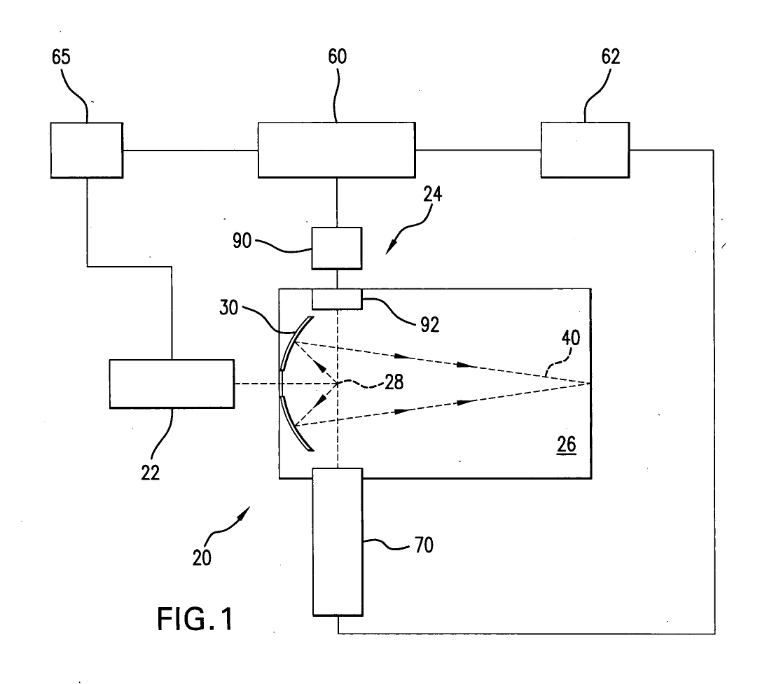

With initial reference to FIG. 1 there is shown a schematic view of an exemplary EUV light source, e.g., a laser produced plasma EUV light source 20 according to an aspect of the present invention. As shown in FIG. 1, and described in further detail below, the LPP light source 20 may include a source 22 for generating light pulses and delivering the light pulses into a chamber 26. As detailed below, the light pulses may travel along one or more beam paths from the source 22 and into the chamber 26 to illuminate one or more target volumes.

As further shown in FIG. 1, the light source 20 may also include a source material delivery system 24, e.g., delivering droplets of a source material into the interior of a chamber 26 to a target volume 28 where the source material targets will be irradiated by one or more light pulses, e.g. a pre-pulse and thereafter a main pulse, to produce a plasma and generate an EUV emission. The source material may include, but is not limited to a material that include tin, lithium, xenon or combinations thereof. The EUV emitting element, e.g. tin, lithium, xenon, etc., may be in the form of liquid droplets and/or solid particles contained within liquid droplets or any other form which delivers the EUV emitting element to the target volume in discrete amounts. In some cases, the droplets may include an electrical charge allowing the droplets to be selectively steered toward or away from the target volume 28.

Continuing with FIG. 1, the light source 20 may also include a collector 30, e.g., a reflector, e.g., in the form of a truncated ellipse, e.g. a multi-layer mirror having alternating layers of Molybdenum and Silicon, with an aperture to allow the light pulses generated by the source 22 to pass through and reach the target volume 28. The collector 30 may be, e.g., an elliptical mirror that has a first focus within or near the target volume 28 and a second focus at a so-called intermediate point 40 (also called the intermediate focus 40) where the EUV light may be output from the light source 20 and input to, e.g., an integrated circuit lithography tool (not shown).

The light source 20 may also include an EUV light source controller system 60, which may also include a firing control system 65 for triggering one or more lamps and/or laser sources in the source 22 to thereby generate light pulses for delivery into the chamber 26. The light source 20 may also include a droplet position detection system which may include one or more droplet imagers 70 that provide an output indicative of the position of one or more droplets, e.g., relative to the target volume 28 and provide this output to a droplet position detection feedback system 62, which can, e.g., compute a droplet position and trajectory, from which a droplet error can be computed, e.g. on a droplet by droplet basis or on average. The droplet error may then be provided as an input to the light source controller 60, which can, e.g., provide a position, direction and timing correction signal to the source 22 to control a source timing circuit and/or to control a beam position and shaping system e.g., to change the location and/or focal power of the light pulses being delivered to the chamber 26.

As shown in FIG. 1, the light source 20 may include a droplet delivery control system 90, operable in response to a signal (which in some implementations may include the droplet error described above, or some quantity derived therefrom) from the system controller 60, to e.g., modify the release point of the source material from a droplet delivery mechanism 92 to correct for errors in the droplets arriving at the desired target volume 28.

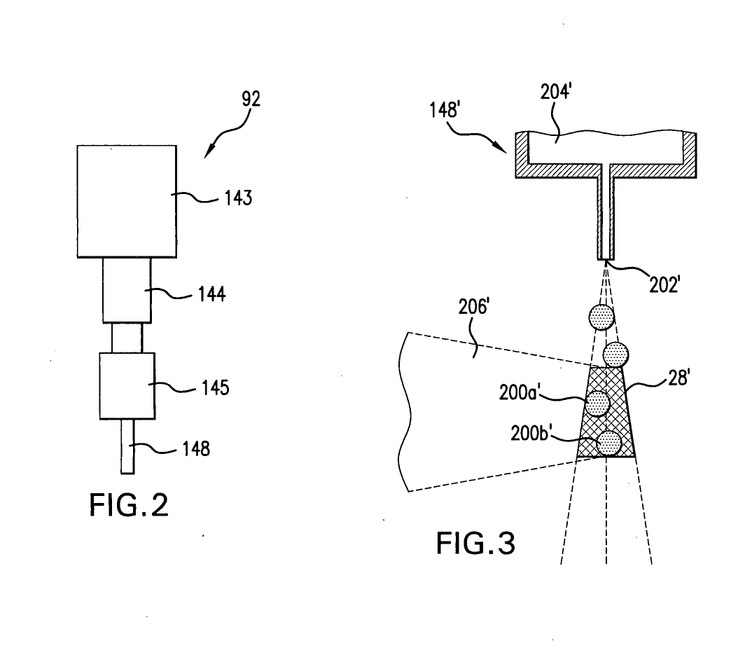

FIG. 2 shows an example of a droplet delivery mechanism 92 in greater detail. As seen there, the droplet delivery mechanism 92 may include a pressurized cartridge 143 holding a molten source material, e.g. tin, lithium, etc., under pressure, e.g. using argon gas, and may be configured to pass the molten source material through a set of filters 144, 145 which may be for example, fifteen and seven microns, respectively, to trap solid inclusions, e.g. tin compounds like oxides, nitrides; metal impurities and so on, of seven microns and larger. From the filters 144, 145, the source material may pass to a dispenser 148.

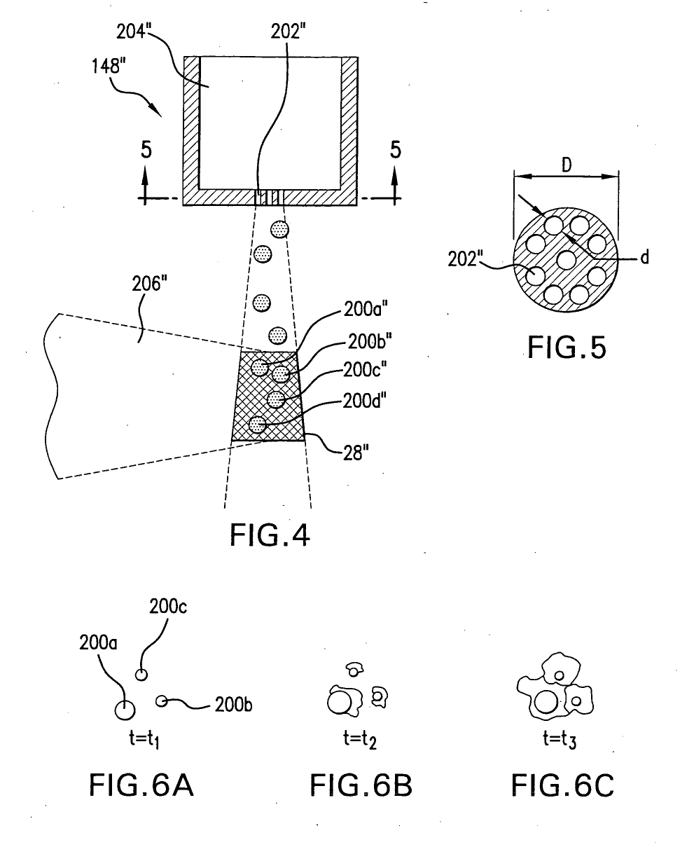

FIGS. 3 and 4 show two different embodiments of droplet dispensers 148′, 148″ for producing and delivering a plurality of droplets to a target volume 28′, 28″ such that two or more droplets (e.g. droplets 200a′, 200b′ in FIG. 3; e.g. droplets 200a″, 200b″, 200c″ and 200d″ in FIG. 4) may simultaneously reside in the target volume 28″, 28″, as shown. In more detail, FIG. 3 shows a source material dispenser 148 having a single orifice 202′ through which source material 204′ is passed through to create either 1) a stream of droplets exiting the dispenser or 2) a continuous stream which exits the dispenser 148′ and subsequently breaks into droplets due to surface tension. In either case, a plurality of droplets are generated and delivered to the target volume 28′ such that two or more droplets may simultaneously reside in the target volume 28′. As detailed further below, the size of the target zone (which is defined, at least partially, by the light beam used to irradiate droplets in the target zone) may in some cases be larger than the size of a single droplet, allowing the EUV light source may accommodate a stream of droplets that are not necessarily uniform in size or position (e.g. position relative to a line extending from the orifice to the center of the target volume and/or position relative to other droplets released from the same orifice). Thus, for some embodiments, a non-modulating dispenser may be used. As used herein, the term “non-modulating dispenser” and its derivatives means a dispenser which does not utilize an input signal have a frequency at or near the droplet formation frequency for droplets formed through one dispenser orifice. Notwithstanding the above described benefits of non-modulating dispensers, for certain applications, the light sources described herein may utilize and benefit from a modulating dispenser such as one of the dispensers described and claimed in U.S. patent application Ser. No. 11/067,124 filed on Feb. 25, 2005, entitled METHOD AND APPARATUS FOR EUV PLASMA SOURCE TARGET DELIVERY, U.S. patent application Ser. No. 11/174,443 filed on Jun. 29, 2005, entitled LPP EUV PLASMA SOURCE MATERIAL TARGET DELIVERY SYSTEM, the contents of both of which were previously incorporated by reference.

FIGS. 4 and 5 illustrate a non-modulating, multiple orifice, source material dispenser 144″ which generates a plurality of droplets for simultaneous irradiation at a target volume 28″ by a light pulse, e.g. pre-pulse, to vaporize and expand the source material for subsequent exposure to a laser pulse, e.g. main pulse, to generate an EUV emission. In more detail, FIGS. 4 and 5 show a source material dispenser 148″ having nine orifices, (of which representative orifice 202″ has been labeled) through which source material 204″ is passed through to create for each orifice either 1) a stream of droplets exiting the dispenser or 2) a continuous stream which exits the dispenser 148″ and subsequently breaks into droplets due to surface tension. Although nine orifices are shown, it is to be appreciated that more than nine and as few as two orifices may be employed to create a suitable multiple orifice dispenser. As shown, for the dispenser 148″, a plurality of droplets are generated and delivered to the target volume 28″ such that two or more droplets may simultaneously reside in the target volume 28″. With this arrangement, effective laser—droplet coupling may, in some cases, be obtained without the use of one or more of the following components described above; the firing control system 65, the droplet position detection system, droplet imagers 70, droplet position detection feedback system 62, and/or the droplet delivery control system 90.

As detailed further below, the size of the target zone (which is defined, at least partially, by the light beam used to irradiate droplets in the target zone) may in some cases be larger than the size of a single droplet, allowing the EUV light source may accommodate a stream of droplets that are not necessarily uniform in size or position. Thus, for some embodiments, a non-modulating dispenser may be used. Notwithstanding the above described benefits of non-modulating dispensers, for certain applications, the light sources described herein may utilize and benefit from modulating dispensers as described above. For example, a plurality of modulating dispensers may be used to create a “showerhead-type” effect similar to the multiple orifice dispenser 148″ shown.

FIGS. 3 and 4 also illustrate respective light beam paths 206′, 206″ along which light pulses from the source 22 may travel to reach the target volume. As illustrated in FIGS. 3 and 4, the light beam paths may be focused to a focal spot, however, it is to be appreciated that the focal spot need not necessarily lie within the target volume. Stated another way, the pulses traveling along beam paths 206′, 206″ may be unfocused, may be focused to a focal spot within the target volume, may be focused to a focal spot at a location along the optical path between the source 22 and target volume 28′, 28″ or may be focused to a focal spot at a location wherein the target volume 28′, 28″ is positioned along the optical path between the source 22 and focal spot.

To restate, FIGS. 3 and 4 illustrate that a plurality of droplets may be disposed in a target volume 28′, 28″ for simultaneous irradiation by a light pulses, e.g. a pre-pulse to vaporize and expand the source material, and a subsequent main pulse to generate an EUV emission from the expanded source material. FIG. 6 illustrates the vaporization and expansion of several droplets 200a-c in a target volume after irradiation by a single light pulse. As shown, at t=t₁, the droplets are disposed in a target volume and irradiated. Shortly thereafter, at t=t₂, each droplet has become partially vaporized and has expanded, as shown. At time t=t₃, the vapor from individual droplets has coalesced and has formed a somewhat continuous vapor cloud. Depending on the energy of the pre-pulse, the source material may, in some implementations, form a weak plasma. As used herein, the term “weak plasma” and its derivatives means a material which includes ions but which is less than about 1% ionized. After a pre-selected time has elapsed after irradiation with the pre-pulse, the irradiated material may be exposed to a main pulse to create a plasma and generate an EUV emission. It is to be appreciated that the source material may be exposed to more than one “pre-pulse” to vaporize (and in some cases form a weak plasma of) the source material prior to exposure to the main pulse.

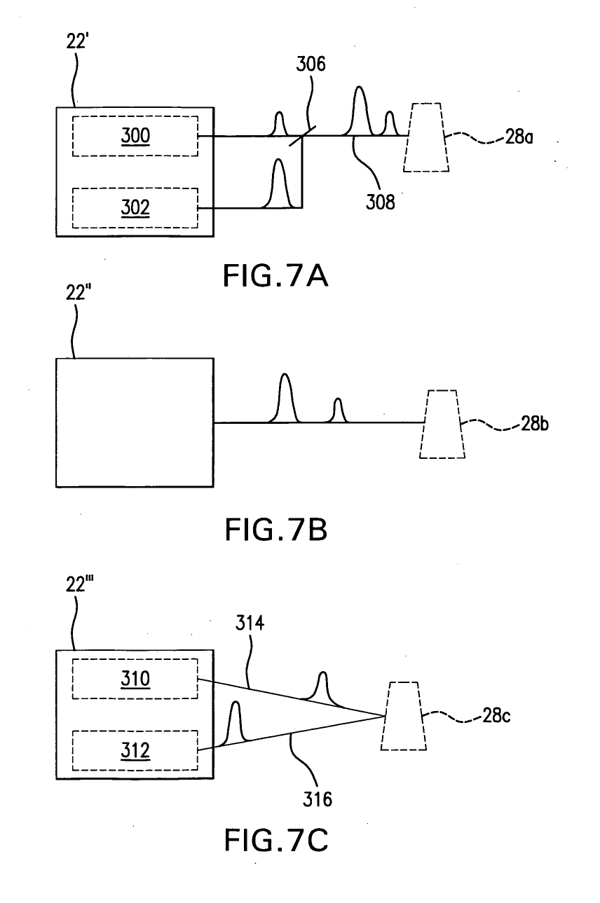

FIG. 7A-C illustrate several suitable embodiments of sources 22′, 22″, 22′″ for generating and delivering the light pulses, e.g. a pre-pulse and main pulse, to the target volume 28a, 28b, 28c. It is to be further appreciated that the pre-pulse(s) may be delivered to a first target volume and the main pulse delivered to a second target volume with the first and second target volumes differing in location and/or size. In more detail, FIG. 7A illustrates an embodiment of a source 22′ in which two separate light sources 300, 302 are used to generate the pre-pulse(s) and main pulse, respectively. FIG. 7A also shows that a beam splitter 306 may employed to combine pulses from the light source 300, 302 along a common beam path 308. Light source 300 may be a lamp, e.g. producing incoherent light, or a laser. Light source 302 is typically a laser, but may be a different type of laser than used for source 300. Suitable lasers include but are not limited to a pulsed CO₂ laser operating at 10.6 μm e.g. with DC or RF excitation, an excimer or molecular fluorine laser operating at high power and high pulse repetition rate. Depending on the application, other types of lasers may also be suitable. For example, a solid state laser, a MOPA configured excimer laser system, e.g., as shown in U.S. Pat. Nos. 6,625,191, 6,549,551, and 6,567,450, an excimer laser having a single chamber, an excimer laser having more than two chambers, e.g., an oscillator chamber and two amplifying chambers (with the amplifying chambers in parallel or in series), a master oscillator/power oscillator (MOPO) arrangement, a power oscillator/power amplifier (POPA) arrangement, or a solid state laser that seeds one or more CO₂, excimer or molecular fluorine amplifier or oscillator chambers, may be suitable. Other designs are possible.

FIG. 7B illustrates an embodiment of a source 22′ in which a single laser is used to produce the pre-pulse(s) and the main pulse. FIG. 7C illustrates an embodiment of a source 22′″ in which two separate light sources 310, 312 are used to generate the pre-pulse(s) and main pulse, respectively. FIG. 7C also shows that pulses from the light sources 310, 312 may travel along different beam paths 314, 316 to reach the target volume 28c. Light source 310 may be a lamp, e.g. producing incoherent light, or a laser.

In one implementation, a single orifice nozzle (see FIG. 3) may be used having an orifice diameter of 10 microns or less to produce droplets having a diameter of about 20 microns or less. The nozzle and source material, e.g. Sn or Li may be heated well above its melting point to prevent nozzle clogging. For multiple Sn droplets, a suitable pre-pulse may be, for example a 1-10 mJ pulse from a Nd-YAG laser having a pulsewidth >10 nsec and focused to 100-200 micron spot at the target volume to vaporize and expand the droplets. The pre-pulse laser may shoot at fixed repetition rate and, in some cases may be synchronized with a main pulse laser which may be, for example, a CO₂ laser operating at 10.6 μm. The CO₂ laser may be triggered about 1-100 μs after the pre-pulse, allowing the source material vapor to present a 300-400 micron target to the CO₂ laser. Larger vapor targets may be exposed, however, as indicated above, the maximum target size may be limited by etendue number, which may be as much as 600-800 microns.

In another implementation, a multiple orifice nozzle (see FIG. 4) may be used having a nozzle diameter, D of 100-200 microns (see FIG. 5) and formed with several orifices, and in some cases 20-30 orifices, or more of diameter, d of about 10 microns which may be organized in concentric circles, randomly or linearly. With more than one orifice, clogging of one or even a few orifices is not critical to EUV production and, thus, the lifetime of droplet generator can be greatly increased. With this arrangement, droplets having a diameter of about 20 microns or less may be produced. The nozzle and source material, e.g. Sn or Li may be heated well above its melting point to prevent nozzle clogging. For multiple Sn droplets, a suitable pre-pulse may be, for example a 1-10 mJ pulse from a Nd-YAG laser having a pulsewidth >10 nsec and focused to 100-200 micron spot at the target volume to vaporize and expand the droplets. The pre-pulse laser may shoot at fixed repetition rate and, in some cases may be synchronized with a main pulse laser which may be, for example, a CO₂ laser operating at 10.6 μm. The CO₂ laser may be triggered about 1-100 μs after the pre-pulse, allowing the source material vapor to present a 300-800 micron target to the CO₂ laser. A considerable reduction of material consumption may be obtained with this implementation as compared with a single droplet of 100 um. The ratio of areas is 100*100/20*10*10≈5 gives the estimate of material consumption rate reduction.

It will be understood by those skilled in the art that the aspects of embodiments of the present invention disclosed above are intended to be preferred embodiments only and not to limit the disclosure of the present invention(s) in any way and particularly not to a specific preferred embodiment alone. Many changes and modification can be made to the disclosed aspects of embodiments of the disclosed invention(s) that will be understood and appreciated by those skilled in the art. The appended claims are intended in scope and meaning to cover not only the disclosed aspects of embodiments of the present invention(s) but also such equivalents and other modifications and changes that would be apparent to those skilled in the art. While the particular aspects of embodiment(s) described and illustrated in this patent application in the detail required to satisfy 35 U.S.C. § 112 are fully capable of attaining any above-described purposes for, problems to be solved by or any other reasons for or objects of the aspects of an embodiment(s) above described, it is to be understood by those skilled in the art that it is the presently described aspects of the described embodiment(s) of the present invention are merely exemplary, illustrative and representative of the subject matter which is broadly contemplated by the present invention. The scope of the presently described and claimed aspects of embodiments fully encompasses other embodiments which may now be or may become obvious to those skilled in the art based on the teachings of the Specification. The scope of the present invention is solely and completely limited by only the appended claims and nothing beyond the recitations of the appended claims. Reference to an element in such claims in the singular is not intended to mean nor shall it mean in interpreting such claim element “one and only one” unless explicitly so stated, but rather “one or more”. All structural and functional equivalents to any of the elements of the above-described aspects of an embodiment(s) that are known or later come to be known to those of ordinary skill in the art are expressly incorporated herein by reference and are intended to be encompassed by the present claims. Any term used in the specification and/or in the claims and expressly given a meaning in the Specification and/or claims in the present application shall have that meaning, regardless of any dictionary or other commonly used meaning for such a term. It is not intended or necessary for a device or method discussed in the Specification as any aspect of an embodiment to address each and every problem sought to be solved by the aspects of embodiments disclosed in this application, for it to be encompassed by the present claims. No element, component, or method step in the present disclosure is intended to be dedicated to the public regardless of whether the element, component, or method step is explicitly recited in the claims. No claim element in the appended claims is to be construed under the provisions of 35 U.S.C. §112, sixth paragraph, unless the element is expressly recited using the phrase “means for” or, in the case of a method claim, the element is recited as a “step” instead of an “act”.

I/We claim:

1. A method for generating EUV light, said method comprising the acts of:
providing a source material;
generating a plurality of source material droplets;
simultaneously irradiating a plurality of source material droplets with a first light pulse to create irradiated source material; and thereafter
exposing said irradiated source material to a second light pulse to generate EUV light.

2. A method as recited in claim 1 wherein said irradiated source material comprises vaporized source material.

3. A method as recited in claim 1 wherein said irradiated source material comprises a weak plasma.

4. A method as recited in claim 1 wherein said exposing act generates a plasma.

5. A method as recited in claim 1 wherein said second light pulse is generated by a CO₂ laser.

6. A method as recited in claim 1 wherein said first light pulse is generated by a CO₂ laser.

7. A method as recited in claim 1 wherein said source material comprises Sn.

8. A method as recited in claim 1 wherein each droplet in said plurality of source material droplets has a diameter in the range of 5 μm to 100 μm.

9. A method as recited in claim 1 wherein each droplet in said plurality of source material droplets has a diameter in the range of 5 μm to 15 μm.

10. A method as recited in claim 1 wherein a CO₂ laser is used to generate said second light pulse, said second light pulse is focused to a focal spot having a focal spot size and said method further comprises the act of:
waiting a predetermined time after said exposing act to allow said irradiated source material to expand to at least said focal spot size before initiating said exposing act.

11. A method as recited in claim 10 wherein said predetermined time is in the range of 1 μs to 100 μs.

12. A method for generating EUV light, said method comprising the acts of:
providing a source material;
generating at least one source material droplet;
irradiating said at least one source material droplet with a first light pulse to create irradiated source material; and
exposing said irradiated source material to a second light pulse to generate EUV light, said second light pulse being focused to a focal spot having a focal spot size, and wherein a predetermined period of time is allowed to pass between said irradiating act and said exposing act to allow said irradiated source material to expand to at least said focal spot size before initiating said exposing act.

13. A method as recited in claim 12 wherein said predetermined time is in the range of 1 μs to 100 μs.

14. A method as recited in claim 12 wherein said irradiated source material comprises vaporized source material.

15. An EUV light source comprising:
a droplet generator delivering a plurality of source material droplets to a target volume;
a source of a first light pulse for simultaneously irradiating a plurality of source material droplets in said target volume with said first pulse to produce an irradiated source material; and
a source of a second light pulse for exposing said irradiated source material to said second light pulse to generate EUV light.

16. An EUV light source as recited in claim 15 wherein said droplet generator comprises a non-modulating droplet generator.

17. An EUV light source as recited in claim 15 wherein said droplet generator comprises a multi-orifice nozzle.

18. An EUV light source as recited in claim 15 wherein said droplet generator comprises:
a source material reservoir having a wall and formed with an orifice;
an electro-actuatable element spaced from said wall and operable to deform said wall and modulate a release of source material from said droplet generator.

19. An EUV light source as recited in claim 15 wherein each droplet in said plurality of source material droplets has a diameter in the range of 5 μm to 100 μm.

20. An EUV light source as recited in claim 15 wherein each droplet in said plurality of source material droplets has a diameter in the range of 5 μm to 15 μm.
